(19) United States
(12) Patent Application Publication
(10) Pub. No.: US 2004/0028972 A1
(43) Pub. Date: Feb. 12, 2004

(54) Method and apparatus for fuel cell thermal management

(75) Inventor: Ronald Scott Bunker, Niskayuna, NY (US)

Correspondence Address: General Electric Company, CRD Patent Docket Rm 4A59, P.O. Box 8, Bldg. K-1, Schenectady, NY, 12301, US

(73) Assignee: General Electric Company

(21) Appl. No.: 10/216,375

(22) Filed: Aug. 12, 2002

(51) Int. Cl. H01M 8/02

(52) U.S. Cl. 429/26; 429/13

(57) ABSTRACT

A fuel cell assembly comprising: a first fuel cell unit adapted for generating electrical power from a fuel flow and an oxidant flow; and a fluid heat exchanger adapted for transferring heat between the fuel cell unit and a heat exchanging fluid flow.

### BACKGROUND

The present invention relates generally to the field of thermal management of fuel cells and more specifically to the use of fluid heat exchangers for thermal management of fuel cell stacks.

In a wide variety of applications, fuel cell stacks, such as, for example, solid oxide fuel cell stacks, have demonstrated a potential for high efficiency and low pollution in power generation. It is desirable that a fuel cell stack design allow for staging of fuel cell units and also allow for in-stack fuel reforming . However, problems associated with thermal management persist, particularly as regards intercooling of the fluid between a first fuel cell unit and a second fuel cell unit. Accordingly, opportunites exist for improved thermal management of the fuel cell stacks.

### SUMMARY

The opportunities described above are addressed, in one embodiment of the present invention, by a fuel cell assembly comprising a first fuel cell unit adapted for generating electrical power from a fuel flow and an oxidant flow; and a fluid heat exchanger adapted for transferring heat between the fuel cell unit and a heat exchanging fluid flow.

### DRAWINGS

These and other features, aspects, and advantages of the present invention will become better understood when the following detailed description is read with reference to the accompanying drawings in which like characters represent like parts throughout the drawings, wherein:

FIG. 1 illustrates an isometric drawing of a fuel cell unit.

FIG. 2 illustrates an isometric drawing of a fuel cell assembly in accordance with one embodiment of the present invention.

FIG. 3 illustrates an isometric drawing of a fuel cell assembly in accordance with a more detailed embodiment of the present invention.

FIG. 4 illustrates an isometric drawing of a fuel cell stack.

### DETAILED DESCRIPTION

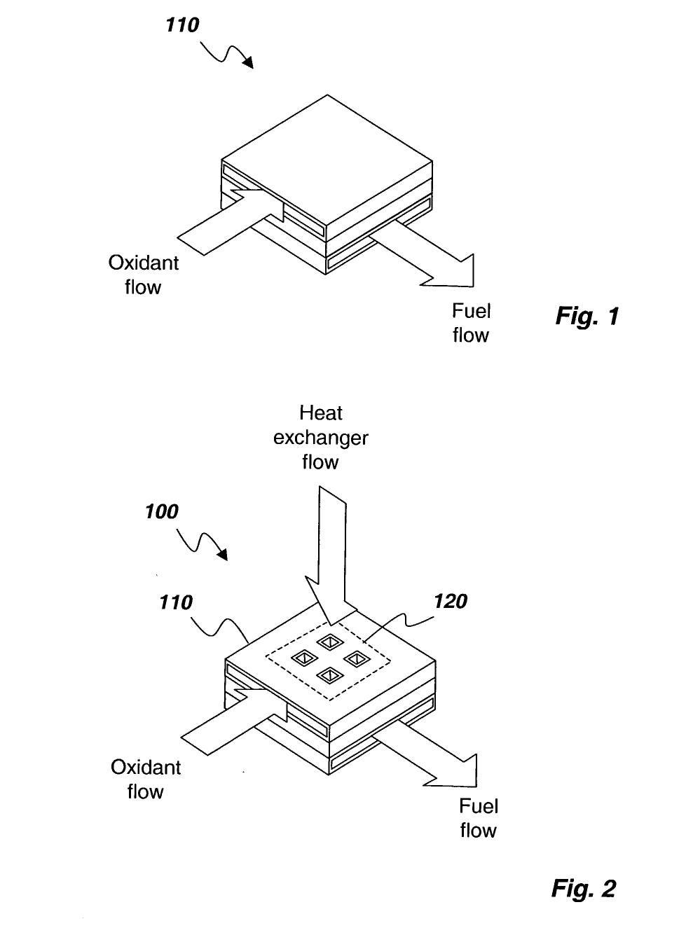

FIG. 1 illustrates an isometric drawing of a fuel cell unit showing a fuel flow and an oxidant flow.

In accordance with one embodiment of the present invention, FIG. 2 illustrates an isometric drawing of a fuel cell assembly 100 comprising a first fuel cell unit 110 and a fluid heat exchanger 120. In operation, first fuel cell unit 110 generates electrical power from the fuel flow and the oxidant flow. Fluid heat exchanger 120 transfers heat between fuel cell unit 110 and a heat exchanging fluid flow.

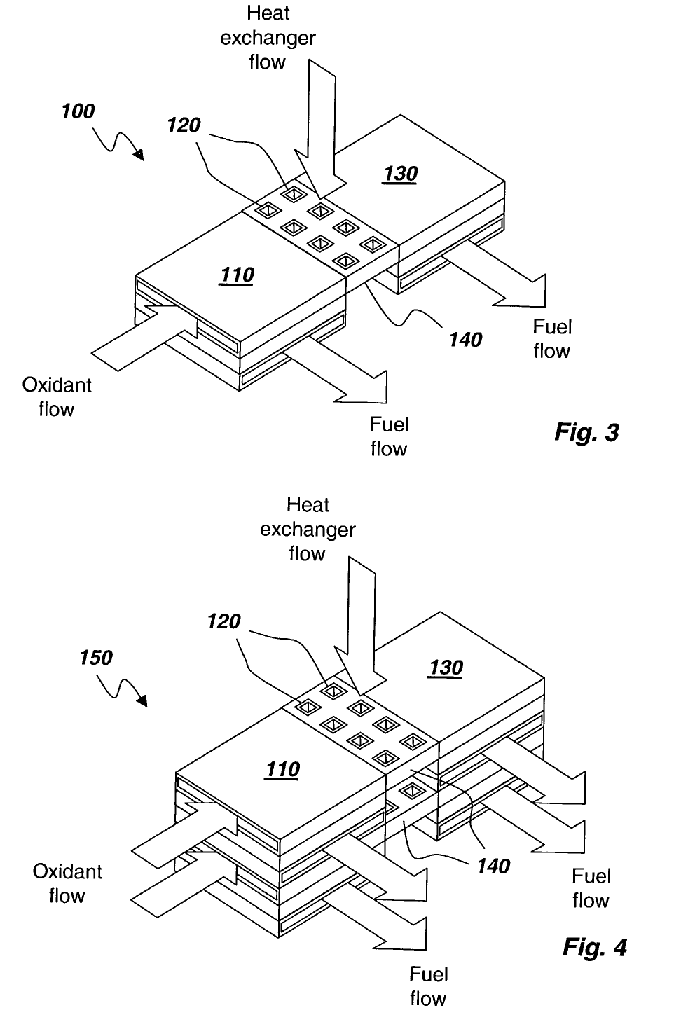

In accordance with another more detailed embodiment of the present invention, FIG. 3 illustrates fuel cell assembly 100 further comprising a second fuel cell unit 130 and an interconnection unit 140. Interconnection unit 140 electrically and fluidically couples first fuel cell unit 110 to second fuel cell unit 130. According to a particular embodiment, fluid heat exchanger 120 is disposed inside interconnection unit 140.

First fuel cell unit 100 and second fuel cell unit 130 comprise any device or system capable of performing the indicated operations using a fuel cell. Examples of fuel cells include, without limitation, solid oxide fuel cells, proton exchange membrane fuel cells, molten carbonate fuel cells, phosphoric acid fuel cells, alkaline fuel cells, direct methanol fuel cells, regenerative fuel cells, zinc air fuel cells, and protonic ceramic fuel cells.

In another embodiment of the present invention, first fuel cell unit 110 and second fuel cell unit 130 comprise at least one planar fuel cell. In still another embodiment of the present invention, first fuel cell unit 110 and second fuel cell unit 130 comprise at least one tubular fuel cell.

FIG. 4 illustrates an isometric drawing of an exemplary fuel cell stack 150. Fluid heat exchanger 120 comprises any heat exchanging fluid capable of transferring heat from first fuel cell unit 110. According to one embodiment, the heat exchanging fluid and the oxidant are supplied from the same source. In an alternative embodiment, the heat exchanging fluid flow and the oxidant flow are supplied from distinct sources. Examples of heat exchanging fluids include, without limitation, air, steam, oxygen, hydrogen, water, helium, reformed fuel, unreformed fuel, and combinations thereof. Heat transfer from first fuel cell unit 110 and the heat exchanging fluid beneficially maintains a thermal gradient of fuel cell stack 150 within a predetermined range or limit. In those embodiments wherein the heat exchanging fluid is unreformed fuel, the heat transfer additionally serves to reform the fuel for subsequent use in electric power generation.

In another embodiment, first fuel cell unit 110 and second fuel cell unit 130 have the fuel flow parallel to the oxidant flow. In an alternative embodiment, the fuel flow is antiparallel to the oxidant flow. In still another alternative embodiment, as illustrated in FIG. 3 and FIG. 4, the fuel flow is orthogonal to the oxidant flow. In accordance with the embodiment of the present invention illustrated in FIG. 3 and FIG. 4, the heat exchanging fluid flow is orthogonal to the fuel flow and the oxidant flow.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A fuel cell assembly comprising:
a first fuel cell unit adapted for generating electrical power from a fuel flow and an oxidant flow; and
a fluid heat exchanger adapted for transferring heat between said first fuel cell unit and a heat exchanging fluid flow.

2. The fuel cell assembly of claim 1, wherein said heat exchanging fluid flow is orthogonal to said fuel flow and said oxidant flow.

3. The fuel cell assembly of claim 1, further comprising:
a second fuel cell unit; and
an interconnection unit adapted for electrically and fluidically coupling said first fuel cell unit to said second fuel cell unit.

4. The fuel cell assembly of claim 3, wherein said fluid heat exchanger is disposed inside said interconnection unit.

5. The fuel cell assembly of claim 1, wherein said heat exchanging fluid flow and said oxidant flow are supplied from distinct sources.

6. The fuel cell assembly of claim 1, wherein said heat exchanging fluid flow comprises a heat exchanging fluid selected from the group consisting of air, steam, oxygen, hydrogen, helium, water, reformed fuel, unreformed fuel, and combinations thereof.

7. A fuel cell assembly comprising:
a first fuel cell unit adapted for generating electrical power from a fuel flow and an oxidant flow;
a fluid heat exchanger adapted for transferring heat between said first fuel cell unit and a heat exchanging fluid flow, said heat exchanging fluid flow being orthogonal to said fuel flow and said oxidant flow;
a second fuel cell unit; and
an interconnection unit adapted for electrically and fluidically coupling said first fuel cell unit to said second fuel cell unit.

8. The fuel cell assembly of claim 7 wherein said fluid heat exchanger is disposed inside said interconnection unit.

9. The fuel cell assembly of claim 7 wherein said heat exchanging fluid flow and said oxidant flow are supplied from distinct sources.

10. The fuel cell assembly of claim 7 wherein said heat exchanging fluid flow comprises a heat exchanging fluid selected from the group consisting of air, steam, oxygen, hydrogen, helium, water, reformed fuel, unreformed fuel, and combinations thereof.

11. A method comprising:
generating electrical power from a fuel flow and an oxidant flow using a first fuel cell unit; and
transferring heat between said first fuel cell unit and a heat exchanging fluid flow using a fluid heat exchanger.

12. The method of claim 11 wherein said heat exchanging fluid flow is orthogonal to said fuel flow and said oxidant flow.

13. The method of claim 11 further comprising:
generating electrical power from said fuel flow and said oxidant flow using a second fuel cell unit; and
electrically and fluidically coupling said first fuel cell unit to said second fuel cell unit using an interconnection unit.

14. The method of claim 13 wherein said fluid heat exchanger is disposed inside said interconnection unit.

15. The method of claim 11 wherein said heat exchanging fluid flow and said oxidant flow are supplied from distinct sources.

16. The method of claim 11 wherein said heat exchanging fluid flow comprises a heat exchanging fluid selected from the group consisting of air, steam, oxygen, hydrogen, helium, water, reformed fuel, unreformed fuel, and combinations thereof.

17. A method comprising:
generating electrical power from a fuel flow and an oxidant flow using a first fuel cell unit; and
transferring heat between said first fuel cell unit and a heat exchanging fluid flow using a fluid heat exchanger, said heat exchanging fluid flow being orthogonal to said fuel flow and said oxidant flow;
generating electrical power from said fuel flow and said oxidant flow using a second fuel cell unit; and
electrically and fluidically coupling said first fuel cell unit to said second fuel cell unit using an interconnection unit.

18. The method of claim 17 wherein said fluid heat exchanger is disposed inside said interconnection unit.

19. The method of claim 17 wherein said heat exchanging fluid flow and said oxidant flow are supplied from distinct sources.

20. The method of claim 17 wherein said heat exchanging fluid flow comprises a heat exchanging fluid selected from the group consisting of air, steam, oxygen, hydrogen, helium, water, reformed fuel, unreformed fuel, and combinations thereof.
